(19) United States
(12) Patent Application Publication
(10) Pub. No.: US 2002/0158824 A1
(43) Pub. Date: Oct. 31, 2002

(54) Device for inputting and/or outputting information

(76) Inventor: Jan Peter Janssen, Hannover (DE)

Correspondence Address: Michale J. Striker, Striker Striker & Stenby, 103 East Neck Road, Huntington, NY, 11743, US

(21) Appl. No.: 09/936,548

(22) PCT Filed: Jan. 12, 2001
(86) PCT No.: PCT/DE01/00118

(30) Foreign Application Priority Data
Jan. 14, 2000 (DE) 10001253.1

(51) Int. Cl. G09G 3/36

(52) U.S. Cl. 345/87

(57) ABSTRACT

A device for information input and/or output is proposed that serves for use in one of the areas of efficiency, physical access control, security technology or building installation practice. The device can be configured for use in each of these areas. The device of the invention is embodied in such a way that it fits into a frame (5) that is suitable for recessed and surface-mounted sockets. The device of the invention has a communications module that establishes the connection with a communications network. The communication between the communications module and the communications network is either hard-wired or wireless. The device of the invention has a touch-sensitive layer (1) as part of the display, so that the display also functions as an input device. The operator control elements on the display are reprogrammed at predetermined intervals. In further refinements, the device has a fingerprint sensor and a card reader.

### PRIOR ART

The invention is based on a device for information input and/or output as generically defined by the preamble to the independent claim.

It is already known that variously embodied display and operator control units exist for use in the areas of efficiency, physical access control, security technology, and house automation.

### ADVANTAGES OF THE INVENTION

The device according to the invention for information input and/or output having the characteristics of the independent claim has the advantage over the prior art that regardless of the area where the device of the invention is to be used, standard components can be used to make display and operator control units. Advantageously, it is therefore unnecessary to adapt the hardware for the various areas of use. This advantageously leads to a considerably higher number of display and operator control units that are embodied identically. The production of special versions can therefore advantageously be reduced sharply.

By the provisions and refinements recited in the dependent claims, advantageous improvements to the device for information input and/or output defined by the independent claim are possible.

It is especially advantageous that the device according to the invention fits into standard surface-mounted and recessed sockets that have a minimum size of 54 mm and/or a mounting hole spacing of 60 or 60.3 or 83 mm, so that standard surface-mounted and recessed sockets can be used for installing the device of the invention in most European countries and also the United States, since in each case a standard exists that has the aforementioned dimensions. This leads to a considerable saving of time and money.

It is also advantageous that the device of the invention maintains a structural height of a maximum of 12 mm, which advantageously makes it possible to adhere to the recommended maximum distance by which a screen should protrude from a wall.

It is also advantageous that the display has a touch-sensitive layer, and then the display itself can therefore be used as an input device. This advantageously also makes easy reprogramming of the operator control fields possible.

It is also advantageous that the light is enclosed by a plastic film with a diffusion coating, so that the lighting of the liquid crystal is optimized.

It is also advantageous that the display has a liquid crystal, which makes a simple installation technique and power supply possible.

It is furthermore advantageous that the device of the invention is connected to a communications network, so that inputs at the device of the invention are carried to further devices via the communications network, and that via the communications network the possibility exists of monitoring the device of the invention.

It is advantageous that the communications module communicates with the communications network either at intervals or constantly, as a result of which a transmission of the data takes place as needed. It is moreover advantageous that the connection to the communications network is made either in hard-wired or wireless fashion. Thus the device of the invention is connected to the communications network as needed and depending on the existing infrastructure.

It is furthermore advantageous that the operator control fields displayed by the display of the device of the invention are rearranged after a predetermined time, thus enhancing security. Advantageously, the operator control elements on the display are rearranged on a principle of randomness; that is, they are scrambled.

It is furthermore advantageous that the processor makes it possible to undertake a corresponding configuration for use in the areas of efficiency, physical access control, security technology and building installation practice. This is advantageously attained by means of configuration menus.

Finally, it is also advantageous that the device of the invention has a fingerprint sensor and/or a card reader. This makes it possible in a simple way to identify a person unambiguously, which is highly useful, especially for areas involving high security.

### DRAWING

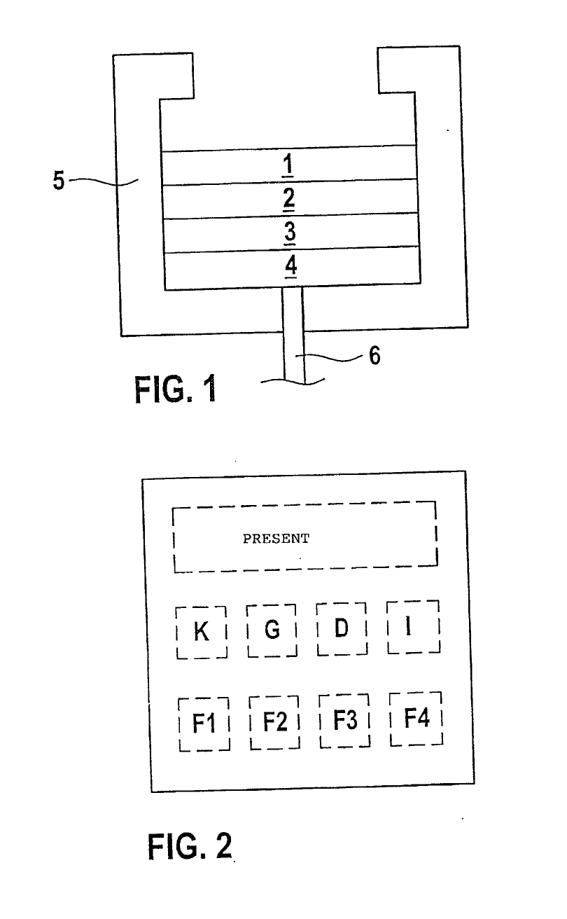

Exemplary embodiments of the invention are shown in the drawing and explained in further detail in the description. FIG. 1 shows a device of the invention, and FIG. 2 shows an example of a display.

### DESCRIPTION

For use in the areas of efficiency, physical access control, security technology and building installation practice (house automation), there are different demand profiles for the display and operator control units; thus only a few different types are all that is needed to satisfy the market for each of these various areas.

According to the invention, a universal device for all of these areas of use is therefore proposed, which permits connection to communications networks and is constructed with standard components and onto which PC programs can be loaded. In particular, the device of the invention is suitable for installation in commercially available recessed and surface-mounted sockets, and the device is secured using standard frames. The device of the invention meets national standards.

In many European countries, there is a standardized mounting hole spacing of 60 mm. Another standard pertains to a minimum internal size of 54 mm. In Great Britain, a standardized size for the mounting hole spacing of 60.3 mm applies, while in the United States it is 83 mm. The device of the invention can be adapted to any size of surface-mounted and recessed socket.

FIG. 1 shows the device for information input and/or output of the invention that can be used for all the areas of use named.

The device of the invention first has a touch-sensitive layer 1, since a display of the device of the invention simultaneously acts as an input device with operator control elements. Located behind the touch-sensitive layer 1 is a liquid crystal 2, by means of which information and operator control elements are shown. The liquid crystal 2 is lighted from behind by a light 3, so that by means of the liquid crystal 2, a clearly visible display of the information is made possible. The touch-sensitive layer 1, liquid crystal 2 and light 3 make up the display and the input device of the device of the invention.

Fluorescent bulbs, incandescent bulbs, or white light emitting diodes are suitable as the light 3. The light 3, the touch-sensitive layer 1 and the liquid crystal 2 are controlled and supplied with energy by an electronic system 4, which is located behind the light 3 and has a processor and a communications module. Memories are connected to the processor, so that by means of the communications module, PC programs can be loaded into the device of the invention. This makes it considerably simpler to prepare these PC programs.

Via the touch-sensitive layer 1, the electronic system 4 receives data pertaining to which fields of the display have been touched, and it compares these data-with the operator control elements shown in order to ascertain which operator control element has been pressed or whether no operator control element was pressed. Based on which operator control element has been pressed, data are generated and shown on the display and optionally transmitted by means of the communications module via the communications network connected to the device.

A so-called analog touch panel is contemplated here as the touch-sensitive layer 1. If pressure is exerted on such a layer, four resistances are created. Depending on the magnitude of the resistances, the position of the pressure point is obtained. Thus if the resistance to the left is greater than to the right, then the pressure point is located farther to the right, since the distance from the left is greater and thus the corresponding resistance is also greater. This applies to all the incident resistances. By suitable evaluation circuits, such as a bridge balance, the individual resistances and thus also the pressure point are evaluated. The analog touch panel is especially well suited to recognizing signatures. The touch panel has glass or plastic plates between which there is elastic material. The pressure point leads to a contact that is connected to the counterpart electrode via the four resistances described. A calibration is necessary here, and a high resolution of 1 mm is possible.

An alternative to the analog touch panel is the digital touch panel. It has a matrix of transparent conductor tracks. Touching the digital touch panel makes a short circuit to a conductor track. By means of an evaluation circuit that is connected to the matrix, it is possible to identify the touch point. The resolution here is not as high as for an analog touch panel.

A second alternative is a touch panel with a grid of infrared rays. Here there are infrared transmitters on two sides, which are not opposite sides, of a square field, while there are infrared receivers on the respective opposite sides. If the square field is touched, the touch point is identified from the fact that an interruption in the rays is ascertained by the infrared receiver. The pressure exerted is measured by an additional pressure sensor. If the exerted pressure is below a predetermined threshold, the touch is ignored. This eliminates effects caused by rain, since touches from droplets of water exert a lesser force on the field than a touch by a person. This touch panel is also secure against vandalism, since the square field is protected by a thick glass or plastic plate, and the infrared transmitter and receiver are protected against damage by a casing. The touch panel with a grid of infrared rays is especially well suited to outdoor use.

In a refinement of the invention, a signature by the user is detected on the touch-sensitive layer and used for identifying the user. To that end, the processor of the electronic system 4 is embodied such that it performs pattern recognition. Signatures vary sharply in terms of the formation of the letters, depending on the person who writes the signature, and an assessment of the individual letters of a signature must therefore be performed. The signature is made either with a pen secured to the device of the invention, or a pen owned by the user.

Alternatively, the device of the invention can have a fingerprint sensor that identifies the user. For the fingerprint sensor, an evaluation electronic system with a signal processor must then be provided. The signature and the fingerprint are especially relevant to areas involving high security.

The electronic system 4 also controls the liquid crystal 2, so that the corresponding information and operator control elements are shown by means of the liquid crystal cells. The light 3, however, is also controlled and regulated by the electronic system 4.

By means of a brightness sensor, mounted on the device of the invention, for ascertaining the background light in the room or space where the device of the invention is located, a closed-loop control circuit can be made with the light 3, so that if the background light is weak, the light 3 shines brightly, while it shines more weakly if the surroundings are bright.

The electronic system 4 is connected to a communications network via lines 6. The communications module in the electronic system 4 is connected to the lines and transmits and receives data over the lines 6. For securing the lines 6 to the communications module, screw clamps are installed for the sake of fastening and tension relief. The power supply can also be achieved via the communications network itself, and alternatively additional lines connect a device of the invention to a power supply grid.

Via the communications network, the electronic system 4 transmits data that have been input, data about the functionality of the device of the invention, and data that indicate the particular areas of use, among those named above, for which the particular device has been configured. Via the communications network and over the lines 6, software updates and configuration data are transmitted to the electronic system 4. Thus from a central location, such as a PC, the device of the invention can be configured as needed. The simplest case of a communications network then is the connection of the device of the invention to a PC.

A frame 5 that fits into the surface-mounted and recessed socket has standard dimensions of 80×80 mm, for instance. If this size of frame 5 is inadequate to receive the device of the invention, recourse can be had to a double frame or even a triple frame. The frame 5 either has clamping devices for mounting it in the surface-mounted and recessed socket, or the device of the invention has bores so that the device of the invention can be screwed to the recessed and surface-mounted socket. The structural height of the device of the invention, which indicates how far the device protrudes into the room from the wall, should be no more than 12 mm, so that it does not seem to protrude too much. The surface-mounted and recessed sockets have a minimum size of 54 mm, and the device is dimensioned such that they are mounted in a surface-mounted and recessed socket. The mounting points in the surface-mounted and recessed sockets have a fixed spacing of 60 mm, and this dimension is taken into consideration as well in the device of the invention.

In the case of a surface-mounted socket, the lines 6 are extended to the outside through a cable lead-through that can be broken out. In the case of recessed sockets, the base or the cylinder ring has cable lead-throughs that can be broken out and through which the lines 6 are then extended to the outside.

The communications network with which the device of the invention is connected is in this case the RS485 network. The RS485 network allows from 32 to 256communications modules and hence devices to be connected in parallel, and the interconnection can be linear, Y-shaped or ring-shaped. In each case only one device is active as a transmitter. The transmission is controlled by a higher-ranking function. The starting signal for transmission, on the condition of transmission readiness, is effected by applying an appropriate address. The maximum distance between two communications modules using a symmetrical two-wire line is 300 to 1200 meters. However, a four-wire connection is also possible.

The device of the invention therefore has an RS485 communications module, which has a typical chip for converting an address setting and which can be recognized from a two-wire network connection. The term “RS485 interface” is a synonym for the RS485 communications module. However, the term communications module will continue to be used hereinafter.

The RS485 communications module is also widely used in PC technology and is distinguished by a small structural size.

Nevertheless, besides the RS485 network, still other communications networks and corresponding communications modules are also possible. For instance, the familiar LSN (Local Security Network) is also possible.

A bus system widely used in house automation can also be used, that is, the European Installation Bus (EIB), which is supported by many vendors.

The EIB requires only two lines, although two further lines can be provided as a reserve. The equipment to be connected is connected parallel. There is no central station in this case, and each station connected to the EIB can send data to any other station. It is thus possible, by suitable addressing, for one computer, such as a PC, to supply data to a group of stations. By structured addressing, a hierarchical architecture is possible. Each station connected to the EIB decides on its own whether to access the EIB. An access method regulates to prevent a loss of information from collisions. Important messages can be handled preferentially by means of a priority mechanism.

The data are transmitted in telegrams, and the telegrams have fields. There is an address field, which has the source address and the destination address. The destination address defines the communications partners, which can be a single station or a group of stations. Besides the address field, there are also a check field and a fuse field, which are useful for error recognition. The items of information to be transmitted are disposed in a data field.

The communication with the communications network takes place either constantly or at predetermined time intervals. The time intervals can either be prespecified, or else the time intervals are determined in accordance with a need for the communication. For instance, if an input is made at the device of the invention, then after the input has been processed, the communications module over the lines 6 reports the data corresponding to the input to a central station, so that these data are then available for further processing. The central station is also connected to the communications network and has a corresponding communications module. Thus here the communication with the communications network takes place only as needed. Alternatively, it is possible for the communications module to transmit data constantly via the communications network, or else the data transfer is performed at predetermined time intervals, for example every hour.

As an alternative to the hard-wired connection to the communications network of the device of the invention, a wireless connection to the communications network is also possible. Then the communications module must be embodied such that it represents a radio interface, which allows the transmission and reception of radio signals. The lines 6 are embodied here as electrical lines. Alternatively, coupling to an optical communications network is also possible, in which case the lines 6 are embodied as optical fiber waveguides. The communications module in that case is an electro-optical and opto-electrical converter for converting the light signals into electrical signals and vice versa.

The light 3 has a plastic film, and a diffusion coating is additionally applied. A suitable plastic film is Makrolon film, which is in granulate form and is suitable for producing injection-molded parts with an optical fiber waveguide connection. It is distinguished by high strength and good heat resistance. It also has excellent electrical and dielectric properties. It can be flameproofed and is physiologically harmless. Most important here, however, is its excellent transparency, when the film is embodied in transparent form. Comparable films are Makrofol film and a polyester film (Reflex LT). Polyester films have a longer service life and better chemical properties.

Another alternative is a mixture of granulate and polyester, which can be procured on the market under the tradename “Bayfol”. The films are in particular printed on the front side, specifically unevenly, in order to compensate for light entering from the side. The house automation is applied to the front side as well.

In a refinement of the invention, it is provided that a card reader is placed between the electronic system and the display. The card reader is embodied in such a way that either a card is inserted into the card reader, or the card communicates with the card reader in touchless fashion.

The card has user-specific data which allow recognition and data callup as well as optionally data reception. If the method of using the card in the card reader is touchless, then the card has a wire coil that is responsible for both supplying energy to the card and transporting information from and to the card reader. The card can then also have a fingerprint sensor with an evaluation circuit, so that the card can be used for authentication. Alternatively, the card reader can also be disposed next to the display, with the evaluation electronics of the card reader being integrated with the electronic system 4.

FIG. 2 shows one example of a display. This involves the area of efficiency. The status “present” shows in the uppermost field, from which it can be concluded that a user has pressed the letter “K” on the operator control field. The field “G” stands for Go, for instance when the user leaves a building, in which case the status “absent” would be showing in the uppermost display field. The field “D” is intended for logging in an authorized absence, and the field “I” stands for information. This makes it possible to call up the current account status of a user. Further inputs are possible using the function keys F1, F2, F3 and F4, which makes it possible for instance to input a configuration.

Since both the display and the operator control elements are shown by means of the liquid crystal 2, the display and operator control unit can be reprogrammed depending on the use or situation. Especially in security-related questions, reprogramming by the device itself is necessary at predetermined time intervals. This enhances security considerably, since it makes it impossible for someone to watch how a security code, for instance, can be input. For this purpose, suitably short time intervals must be selected.

The configuration of the device of the invention can be done for each of the areas of use named, that is, physical access control, efficiency, security technology and house automation. When the device is put into operation, a service technician accordingly indicates a configuration menu, which can also be activated during operation by the actuation of function keys. By suitable configuration menus, the service technician selects appropriate menu points for making the setting. Via the communications network, however, this configuration can also be done from a central station.

For the areas of efficiency and physical access control, there are two possible ways to use the invention: first, with data transmission of the input data via the communications network, and second, storage of the data in the device of the invention. The data are then downloaded as needed from the device of the invention, which can also be done by means of a mobile station, such as a portable computer.

For use in the area of security technology, the menu points for focusing and unfocusing should be configured, and optionally the operator control and information fields on the display should be automatically rearranged after predetermined time intervals.

For the area of house automation, configurations should be made for the following uses: control of rolling-type shutters, light management, power and consumption meters, heating control and energy-saving programs, lock controls, and special points for nursing homes and hospitals.

These last-named uses are merely a selection among others that are also possible.

1. A device for information input and/or output, wherein the device has a processor and a display with a touch-sensitive layer (1), wherein the display has operator control elements and information fields, and wherein the device is connected to a communications network by means of a communications module that is connected to the processor, characterized in that the device is embodied such that the device fits into a frame (5) that is suitable for both a recessed and a surface-mounted socket.

2. The device of claim 1, characterized in that the recessed and surface-mounted socket has a minimum internal size of 54 mm and/or a mounting hole spacing of 60 or 60.3 or 83 mm.

3. The device of claim 1 or claim 2, characterized in that the device has a maximum structural height of 12 mm.

4. The device of claim 3, characterized in that a light (3) is placed behind the display, and that the light (3) has a plastic film with a diffusion coating and an optical fiber waveguide connection.

5. The device of claim 4, characterized in that the display is a liquid crystal display (2).

6. The device of one of the foregoing claims, characterized in that the communications module communicates with the communications network constantly or at intervals.

7. The device of one of the foregoing claims, characterized in that the communications module communicates with the communications network in wireless or hard-wired fashion.

8. The device of one of the foregoing claims, characterized in that the operator control elements and information fields shown by the display are programmable, and a time interval between a reprogramming of the operator control elements and information fields is specified.

9. The device of claim 8, characterized in that the processor rearranges the operator control elements and information fields shown by the display at predetermined time intervals on the principle of randomness.

10. The device of one of the foregoing claims, characterized in that the processor allows a configuration in which the processor offers respective configuration menus for use in the areas of efficiency, physical access control, security technology and building installation practice.

11. The device of one of the foregoing claims, characterized in that the device has a fingerprint sensor.

12. The device of one of the foregoing claims, characterized in that the device of the invention has a card reader.
